(19) United States
(12) Patent Application Publication
(10) Pub. No.: US 2013/0181516 A1
(43) Pub. Date: Jul. 18, 2013

(54) BATTERY AUGMENTATION SYSTEM AND METHOD

(71) Applicant: Taing Foung Phan, Auckland (NZ)

(72) Inventor: Taing Foung Phan, Auckland (NZ)

(21) Appl. No.: 13/877,219

(22) PCT Filed: Oct. 4, 2011
(86) PCT No.: PCT/NZ11/00206

§ 371 Date: Apr. 1, 2013

(30) Foreign Application Priority Data
Oct. 5, 2010 (NZ) 588386
Nov. 2, 2010 (NZ) 588951

(51) Int. Cl. H02J 7/00

(52) U.S. Cl. CPC H02J 7/0029
USPC 307/10.7; 307/48

(57) ABSTRACT

A battery augmentation system and method is disclosed. It is particularly designed for the augmentation of batteries in electric or hybrid vehicles. The system comprises of conversion means operatively connected between an auxiliary power system and a electric-motor-battery of the vehicle, wherein the conversion means converts an output signal from the auxiliary power system into a converted signal. The converted signal supplements the electric-motor-battery output voltage preventing it from dropping below a predefined level, thus preventing damage to the electric-motor-battery. The system makes further use of an external battery which can be charged either by mains power or through the auxiliary power system of the electric/hybrid vehicle allowing the vehicle to be converted to a plug-in capable hybrid/electric vehicle. Once installed, the battery augmentation system improves the power of a hybrid or electric vehicle, extends the useful lifetime of a new or used electric-motor-battery and also improves fuel efficiency of the vehicle.

### FIELD OF THE INVENTION

The invention relates to the augmentation of batteries. More particularly it relates to a battery augmentation system and method for the augmentation of batteries.

### BACKGROUND OF INVENTION

Motor vehicles powered by internal combustion engines, electric motors and other motion means are known. Hybrid vehicles are powered by a combination of such motion means e.g.: the Toyota Prius is powered by both an internal combustion engine and an electric motor.

A hybrid vehicle is classified as either a series or parallel hybrid vehicle depending on the layout of its drive train. A hybrid vehicle with both the internal combustion engine (ICE) and the electric motor directly powering the drive train is known as a parallel hybrid where as an electric vehicle that uses a generator as a range extender is known as a series hybrid.

In parallel and series hybrid vehicles, the main battery of the vehicle is charged through an alternator or generator rotated by the ICE as shown in the diagram PRIOR ART 1.

PRIOR ART 1 shows the configuration of a typical hybrid vehicle where the electric motor is powered by a main hybrid battery which is in turn charged by a generator driven by the ICE. The vehicle's computer (not shown) determines when to use the electric motor and/or the ICE to power the vehicle. The vehicle also has an auxiliary 12V (or 24V) battery to power the electrical components of the vehicle such as lights, radio, wipers, etc. The auxiliary 12V (or 24V) battery is charged through an additional alternator or converter.

PRIOR ART 1A shows an alternative configuration of a hybrid vehicle. In this configuration the electric motor also acts as a generator which charges the main hybrid battery of the vehicle. The output of the electric motor generator is passed through an AC-DC inverter followed by a series of relays that allows for the charging of the battery when required. The electric motor generator also supplies power to the auxiliary battery through a DC-DC converter. Note that this configuration lacks a separate alternator for charging the auxiliary battery and it shares the charging output of the main hybrid battery. The operation of the electric motor generator, the ICE and the main hybrid battery is controlled by one or more ECU units as shown.

In order to understand the issues related to hybrid vehicles, it is important to initially identify the reasons why consumers purchase hybrid vehicles. One of the reasons is because hybrid vehicles are environmentally friendly and is regarded as ‘green’ vehicles. Due to this reason, consumers willingly pay the extra costs involved with new hybrid vehicles even though they can cost up to 5 times more than there gasoline equivalent.

The fact that hybrid vehicles use less gasoline when compared to conventional gasoline powered vehicles allows consumers to save on fuel costs. This is by far the main reason why most people purchase hybrid vehicles. This is especially true for used hybrid vehicles since hybrid vehicles which have been used for 5 years or more typically sell for only a fraction of the cost of new hybrid vehicles, making them more affordable to average consumers.

A further reason why consumers purchase hybrid vehicles is the lower maintenance costs associated with them. Hybrid vehicles are mechanically very reliable and most hybrid owners can attest to the fact that they spend very little time and money on vehicle maintenance. They are also extremely smooth and quiet to operate and when the vehicle is performing correctly, it is quiet, responsive and is a pleasure to drive.

As with any other technology, hybrid vehicles also have a few disadvantages which may deter potential consumers. The high cost associated with hybrid vehicles is one of the main disadvantages of this technology. A brand new hybrid vehicle can cost up to NZ$65,000.

The reliability of hybrid vehicle batteries is also a main concern for potential hybrid vehicle consumers. A used hybrid vehicle aged. 5 years or more is likely to encounter battery problems and will require replacement of the hybrid battery which can usually cost more than the value of the vehicle. For example, a 1998 Toyota Prius hybrid costs about NZ$4000 but a replacement battery is quoted at more than NZ$12,000. A 2001 Toyota Prius hybrid costs about $8000 but its replacement battery is quoted at more than $6000. This is also a concern for existing owners of hybrid vehicles. Owners who have had a used hybrid vehicle aged 5 years or more will always worry about the high cost of battery replacement. If the battery starts to exhibit signs of failure, the vehicle will become very unreliable and will often stop working entirely. Lack of power is noticeable in a hybrid vehicle when the battery pack starts weakening.

The main battery pack in a hybrid vehicle (usually a Nickel Metal Hydride (NiMH) Battery) consists of a plurality of interconnected battery sub-packs (cells) placed in series. It has a service life of approximately 8 to 10 years. These batteries are expensive to replace and as mentioned above sometimes cost more than the total value of the vehicle as mentioned above. Presently, hybrid vehicle manufacturers recommend that the hybrid vehicle battery is replaced at the end of its useful life. To the inventor's knowledge, there have been no attempts by the manufactures to reuse or recondition used batteries to date.

Since 2005 the inventor has been in the business of battery reconditioning, mainly involving lead acid batteries for use in automotive-starting and deep-cycle use. In 2007 the inventor started reconditioning hybrid battery packs for the Toyota Prius.

He has experimented using his own methods and procedures to recondition and rebuild hybrid vehicle batteries. To date he has rebuilt and reconditioned over 300 battery packs, some orders coming from as far as the United Kingdom.

Therefore the inventor is recognised as an expert in this field and is the only person who reconditions battery packs of generation 1 Toyota Prius (NHW10-1997 to 2000) commercially.

In general, the battery pack of a hybrid vehicle fails when one or more of the cells in a sub pack is no longer able to hold and dissipate charge, sometimes going into a state of charge reversal when under stress (note: in the Toyota Prius hybrid battery, there are 120 cells in 40 sub packs connected in series). This should not be confused with their ability to attain maximum charged voltage. A failing battery under charge may still attain correct terminal voltage, giving the appearance that it is fully charged. However when a load is placed on it, the voltage will drop rapidly as the small amount of charge rapidly dissipates with the result that the battery voltage drops very quickly and the battery becomes fully discharged or ‘flat’.

As part of the reconditioning process, the inventor intentionally subjects the sub packs of the battery to a 100 amp load to determine if the sub packs can be reused in a reconditioned and rebuilt battery pack. However even with these extreme testing procedures, the rebuilt batteries still fail within the one year warranty period offered by the inventor, where some batteries failed more than once causing a loss to the inventor while repairing the battery under warranty.

There are several reasons why rebuilt and reconditioned battery packs fail. The main reason is the failure of the sub packs used to rebuild the battery. The owner of the vehicle abusing an already weakened battery pack by heavy acceleration especially during hill climbs could also cause failure of the battery packs. Loss of power in the ICE due to poor maintenance, wear and tear of essential components such as spark plugs, air flow meters, plug in coils, oxygen sensors, etc could also lead to the hybrid battery failure. In general the sub packs fail when they are stressed beyond their capacity to handle a load. However even when the cause of failure of the reconditioned batteries was out of the inventors control he still had to make good on his warranty which caused significant financial losses.

Failure of the reconditioned battery packs put the inventor in a position where he had to find a way to prevent the battery sub packs from failing permanently or decline to do any more work on reconditioning hybrid battery packs.

The inventor had to overcome several problems when inventing a method of preventing the hybrid battery from failing permanently. The main problem to overcome was the prevention of the sub packs of the battery from being stressed beyond their ability to handle the required load in normal and extreme driving conditions. Furthermore the proposed method had to provide support to the hybrid battery pack when required. In other words it had to be “always available and working”. The method also had to be capable of delivering sufficient charge in order to perform these functions.

The proposed solution was also required to be robust and reliable, be small and compact, be easily assembled and installed in a hybrid vehicle and be affordable to consumers.

The inventor believes that there have not been any attempts to address the above problems related to hybrid batteries (in the form of a product or method to support an aging hybrid battery pack) mainly because there has not been anyone else who reconditions hybrid battery packs on a commercial basis. As such the need has never arisen. The practice of the day was to replace the failed battery pack with a new battery pack.

### PRIOR ART

Most developments around the hybrid vehicle were mainly related to providing a plug-in system for the vehicle, since manufacturers were slow to introduce this feature into their release models.

One prior art implementation developed by US company Enginer Inc. (refer PRIOR ART 2), introduced a second battery pack connected in parallel with the main hybrid battery.

As shown in PRIOR ART 2, the second battery pack consists in 4×12V (or similar) deep cycle batteries giving a total voltage of 48VDC which is then converted to ˜310 VDC using a DC to DC converter. The second battery pack is recharged by plugging into a household mains outlet. This makes the hybrid vehicle a limited plug-in vehicle, as it can be driven in electric mode for short distances (20-30 km) and only below certain speeds (50 kmph). Under this system, when the plug in battery pack is depleted it no longer plays any part in the vehicle operations and the vehicle reverts to its original state.

Toyota has since released a plug-in capable Prius (2010) model. These use extra batteries that can be charged from a household mains supply line. The range under electric mode is still limited.

Slow developments in this area are mainly due to the cost of batteries and their ability to store enough energy for long distance driving. Electric vehicles are still limited to a maximum of 60 km range making it suitable only for short trips.

### US 2010/0033132

Discloses a control system which prevents the over-charge/over-discharge of a hybrid vehicle battery using battery state information provided by a battery electronic control unit (ECU). A control device sends operational commands to a motor and ICE of a hybrid vehicle so that the hybrid vehicle battery is not over-charged or over-discharged at any time. This system relies heavily on inputs and outputs calculated by the battery ECU software and any errors in the sensed parameters such as voltage, current or temperature can introduce distortion to the control system. Furthermore the control system does not use any auxiliary power source (such as a secondary battery pack or an auxiliary charging system) to provide supplementary power to the individual hybrid battery sub-packs when they are used in harsh driving conditions involving heavy acceleration of the vehicle. Therefore the individual sub-packs may still be weakened and eventually fail due to the lack of additional power supplementation to the hybrid battery. Even if battery over-discharge is prevented by the control system as described, the vehicle would lack power and use more fuel whenever the battery voltage falls below the over-discharge limit. Furthermore the control system does not provide a method of improving the performance and preventing the failure of already-weakened or reconditioned hybrid batteries.

### US 2010/0241376

Discloses a software and/or hardware implemented ECU for a hybrid vehicle for preventing a hybrid battery from discharging beyond a predetermined limit based on calculations performed by the ECU. The motor and ICE is controlled by the ECU so that battery over-discharge is prevented. As in the previous citation, the ECU does not allow for an auxiliary power source (such as an external battery pack or auxiliary charging system) to provide supplementary power to the individual battery sub-packs when they are used under harsh driving conditions. The inability to prevent battery sub-pack failure and the lack of support for already-weakened or reconditioned hybrid batteries can be identified as weaknesses of this disclosure.

### OBJECT OF THE INVENTION

It is an object of the invention to provide a battery augmentation system and method that ameliorates some of the disadvantages and limitations of the known art or at least provide the public with a useful choice for protecting the battery of a hybrid, electric or other vehicle.

### SUMMARY OF INVENTION

In a first aspect the invention resides in a battery augmentation system comprising, at least one conversion means wherein the conversion means is adapted to be coupled, in use, to an auxiliary power system for receiving an output signal from the auxiliary power system, the conversion means being capable of converting the output signal from the auxiliary power system into a converted signal and the conversion means further being adapted to be coupled, in use, to a battery or battery circuit for providing the battery with the converted signal to thereby supplement the battery, wherein supplementing the battery prevents the battery output voltage from dropping below a predefined level, thus preventing damage to the battery.

Preferably the battery augmentation system is a battery augmentation system for use in a hybrid or electric vehicle and the auxiliary power system includes an alternator, converter or other power conversion means powered by, for example, an internal combustion engine, a regenerative breaking system, one or more batteries, electric motor generators, solar/wind power generators or other means.

Preferably the battery is an electric-motor-battery of the vehicle.

Preferably the battery augmentation system is a battery augmentation system for use in an industrial battery bank and the auxiliary power system is an alternator, converter or other power conversion means powered by mains power or other power source(s).

Preferably the conversion means comprises of inverting means and rectifying means wherein the inverting means converts the output signal from the auxiliary power system into an AC signal, and the rectifying means rectifies the AC signal into the converted signal, the converted signal being a DC converted signal.

Preferably the converted signal prevents the electric-motor-battery output voltage from dropping below a predefined level, particularly when the electric-motor-battery is under stress during heavy demand periods of the electric motor of the vehicle.

Preferably the system further comprises charge storage means coupled to the auxiliary power system of the vehicle.

Preferably the charge storage means is also coupled to a charging unit which allows the charge storage means to be plugged in and charged through AC mains power or other external power sources such as solar powered charging.

Preferably the charge storage means is coupled to the auxiliary charging system such that the charge storage means is continuously charged from the vehicle's auxiliary power system.

Preferably the charge storage means is one or more 12V (or 24V) lead acid, lithium ion or any other type of batteries.

Preferably the charge storage means is capable of supplying an output signal to the conversion means and the system comprises of switching means for selecting an (output signal to be supplied to the conversion means, the output signal being chosen from the auxiliary power system, the charge storage means or both.

Preferably the output signal from the auxiliary power system is a 12V (or 24 V) DC signal and the conversion means converts the 12V (or 24V) DC signal into a DC voltage signal corresponding to the electric-motor-battery voltage.

Preferably the rectifying means includes one or more diode rectifiers, capacitors and current limiting resistors.

Preferably the converted signal prevents the output voltage of the electric-motor-battery from dropping below a predefined level, even when the electric-motor-battery is under stress, the predefined level being a value unique to each type of electric-motor-battery, for example 280V.

Preferably the battery augmentation system is in an ‘always working’ configuration with the electric-motor-battery during operation of the vehicle.

Preferably the battery augmentation system provides increased power and/or an increase in fuel economy to a vehicle with the system installed, and in particular to a vehicle having a suspected weak electric-motor-battery.

Preferably the battery augmentation system is capable of being installed in all hybrid and/or electric vehicles, and in particular in the Toyota Prius (generation 1—NHW10, generation 2—NHW11 and generation 3—NHW20), Honda Insight and Honda Civic hybrid.

Preferably the battery augmentation system is turned on or off by a remote switch or by the ignition switch of the vehicle so that the system turns on or off simultaneously with the vehicle starting or turning off.

Preferably the battery augmentation system further comprise one or more thermistors coupled to the conversion means for limiting the current output from the conversion means preventing the conversion means from overloading.

In another aspect the invention resides in a hybrid or electric vehicle having at least one conversion means wherein the conversion means is operatively connected to an auxiliary power system of the vehicle, the conversion means converting an output signal from the auxiliary power system into a converted signal, the converted signal being supplied to an electric-motor-battery of the vehicle, the converted signal supplementing the electric-motor-battery output voltage, wherein supplementing the electric-motor-battery output voltage with the converted signal prevents the electric-motor-battery output voltage from dropping below a predefined level, thus preventing damage to the electric-motor-battery.

In a further aspect the invention resides in a device for use in a vehicle, wherein the device is adapted to be coupled, in use, to an auxiliary power system of the vehicle for receiving an output signal from the auxiliary power system, the device being capable of converting the output signal from the auxiliary power system into a converted signal and the device further being adapted to be coupled, in use, to an electric-motor-battery or battery circuit of the vehicle for providing the electric-motor-battery with the converted signal to thereby supplement the electric-motor-battery, wherein supplementing the electric-motor-battery prevents the electric-motor-battery output voltage from dropping below a predefined level, thus preventing damage to the electric-motor-battery.

In another aspect the invention resides in a battery augmentation method for augmenting a battery, the method comprising the steps of:
converting an output signal from an auxiliary power system into a converted signal through conversion means,
supplying the converted signal to the battery or battery circuit thereby supplementing the battery output voltage,
   such that supplementing the battery output voltage with the converted signal prevents the battery output voltage from dropping below a predefined level, thus preventing damage to the battery.

Preferably the method includes a preliminary step of connecting conversion means between the auxiliary power system and the battery or battery circuit.

Preferably the method is for augmenting a battery of a vehicle.

Preferably the conversion means includes inverting means and rectifying means.

Preferably the converting of the output signal through the conversion means involves the inverting means converting the output signal into an AC signal and the rectifying means converting the AC signal into a DC converted signal.

In another aspect the invention resides in a battery augmentation system for a hybrid or electric vehicle, the system comprising at least one conversion means, the conversion means capable, in use, of being connected between an auxiliary power system and an electric-motor-battery of the vehicle, wherein the conversion means is capable, in use, of converting an output signal from the auxiliary power system into a converted signal and supplying the converted signal to the electric-motor-battery, thereby supplementing the output voltage of the electric-motor-battery, thus preventing the output voltage of the electric-motor-battery from dropping beyond a predetermined value and preventing damage to battery cells of the electric-motor-battery.

In a further aspect the invention resides in an add-on kit for a hybrid or electric vehicle, the add-on kit having at least one conversion means, the conversion means capable, in use, of being connected between an auxiliary power system and an electric-motor-battery of the vehicle, wherein the conversion means is capable, in use, of converting an output signal from the auxiliary power system into a converted signal and supplying the converted signal to the electric-motor-battery, thereby supplementing the output voltage of the electric-motor-battery, thus preventing the output voltage of the electric-motor-battery from dropping beyond a predetermined value and preventing damage to battery cells of the electric-motor-battery.

In an even further aspect the invention resides in a battery augmentation system comprising, at least one conversion means wherein the conversion means is operatively connected to an auxiliary power system, the conversion means converting an output signal from the auxiliary power system into a converted signal, the converted signal supplementing an output voltage of a battery, wherein supplementing the battery output voltage with the converted signal prevents the battery output voltage from dropping below a predefined level, thus preventing the battery from being damaged.

This invention may also be said to consist in the parts, elements and features referred to or indicated in the specification of the application, individually or collectively, and any or all collectively of any two or more of the parts, elements or features, and where specific integers are mentioned herein which have known equivalents such equivalents are deemed to be incorporated herein as if individually set forth.

These and other aspects, which should be considered in all its novel aspects, will become apparent from the following description, which will be given by way of example only with reference to the accompanying drawings, in which:

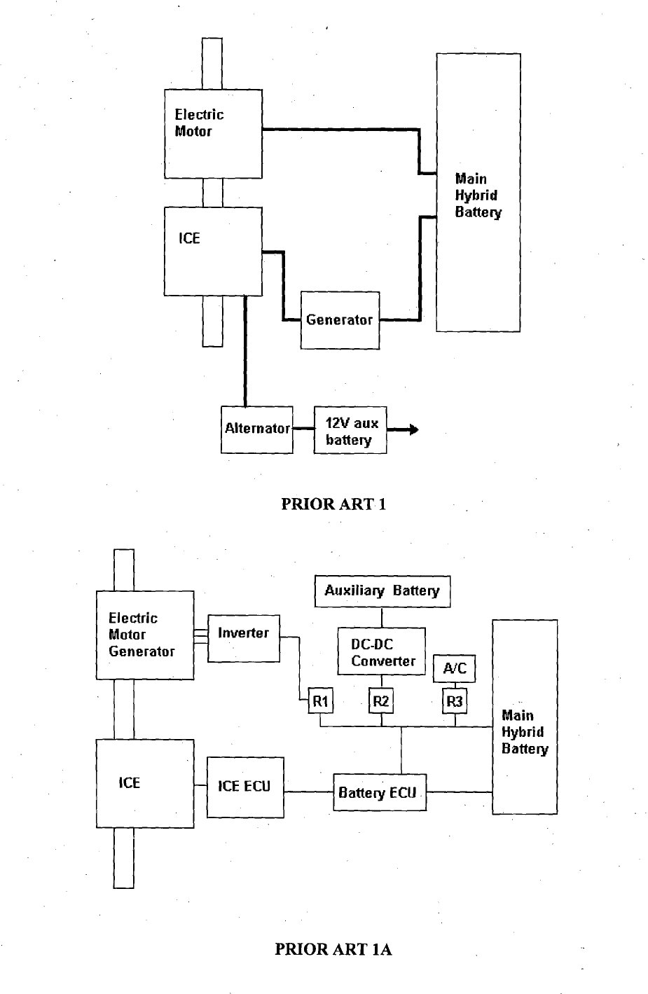

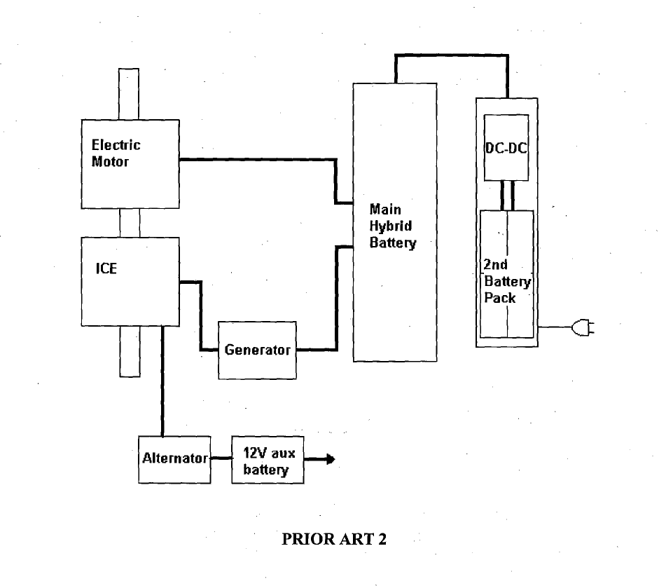

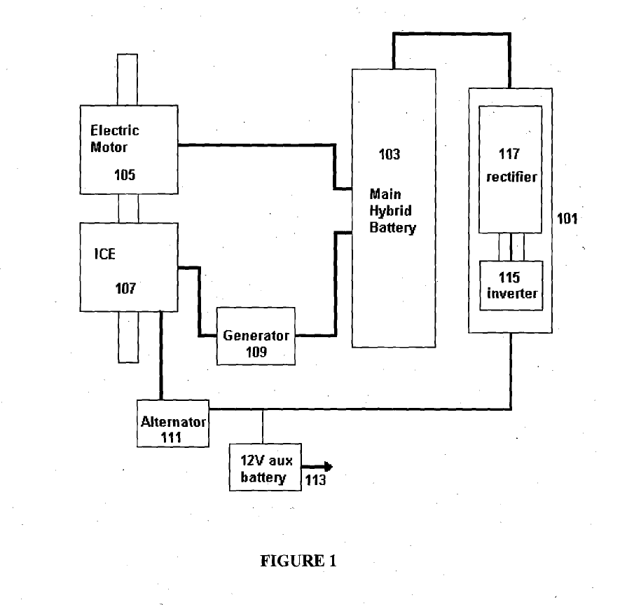

FIG. 1 is a pure form of the battery augmentation system implemented in a hybrid powered vehicle in accordance with a first preferred embodiment of the invention.

FIG. 1A shows the battery augmentation system implemented in an alternative configuration of a hybrid vehicle.

FIG. 2 is a close-up block diagram of the battery augmentation system conversion means.

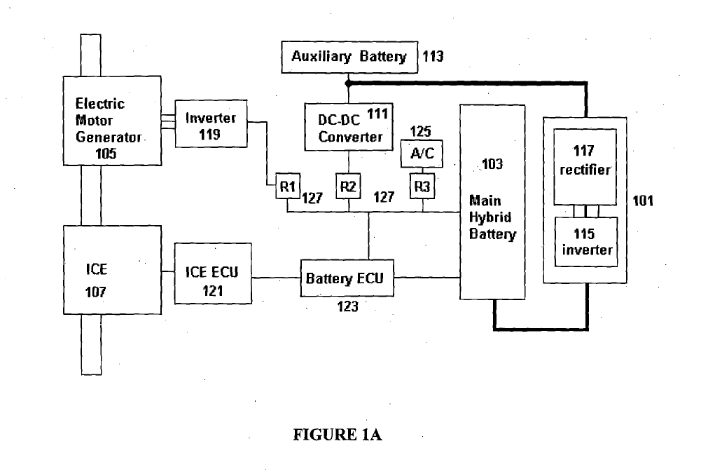

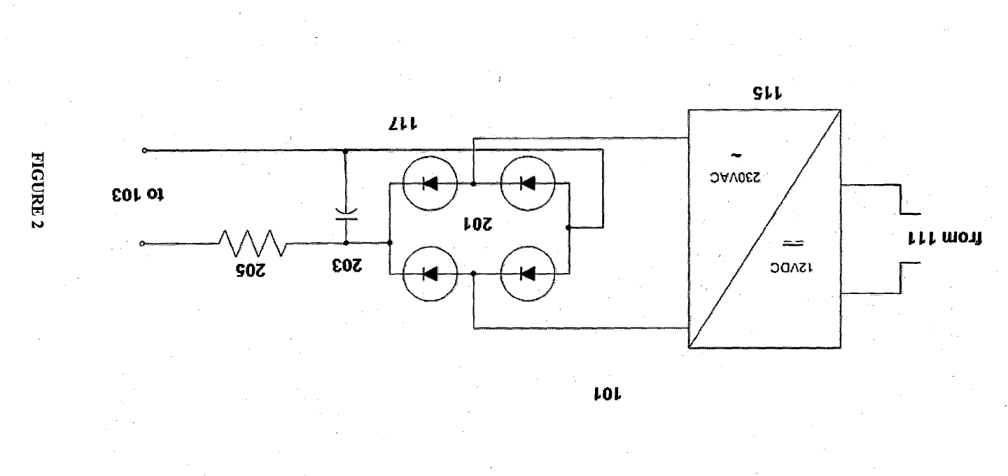

FIG. 3 is a graph showing voltage output of the electric-motor-battery vs. time during trials performed using a hybrid vehicle with and without the battery augmentation system installed.

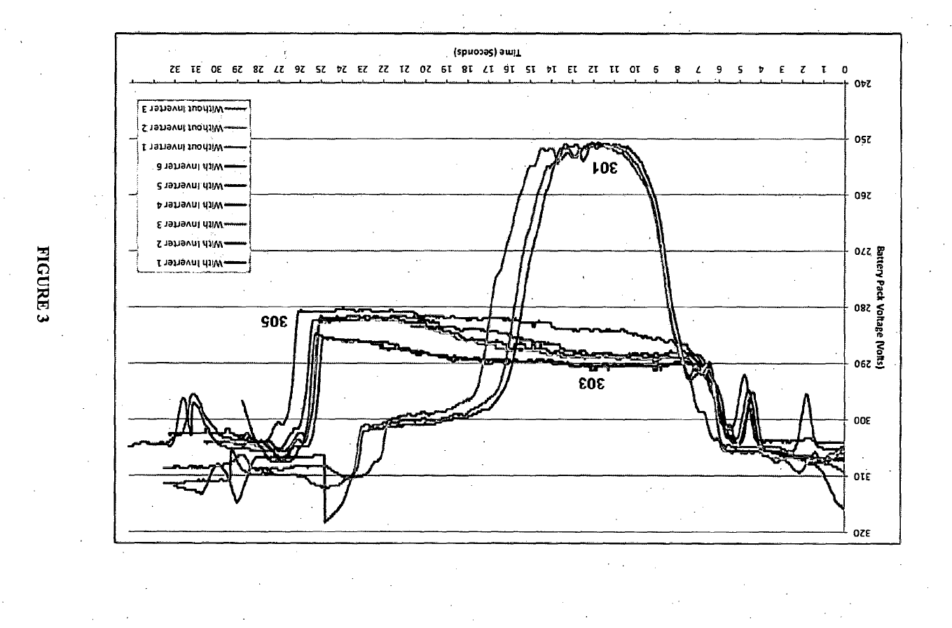

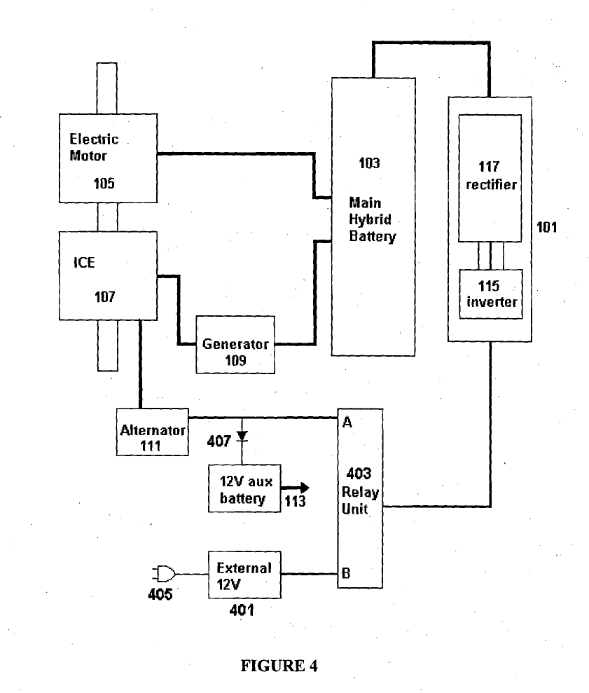

FIG. 4 is an alternative embodiment of the battery augmentation system having plug-in capability incorporating an external battery in accordance with another preferred embodiment of the invention.

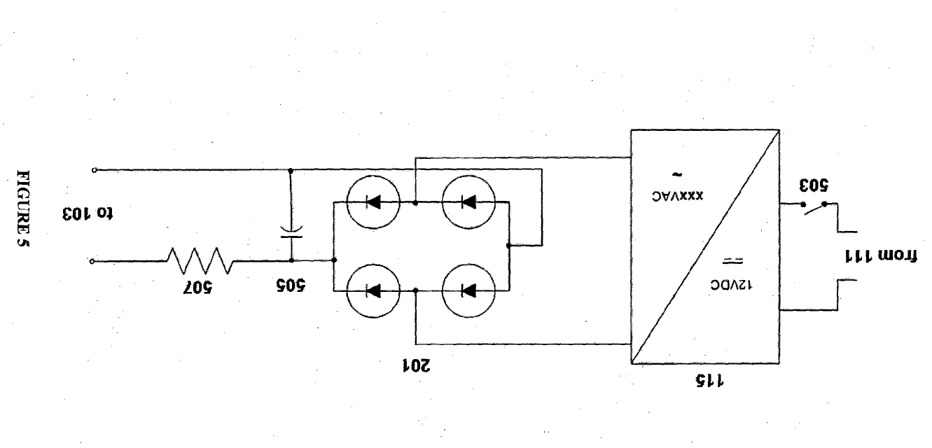

FIG. 5 is an alternative block diagram of the battery augmentation system conversion means.

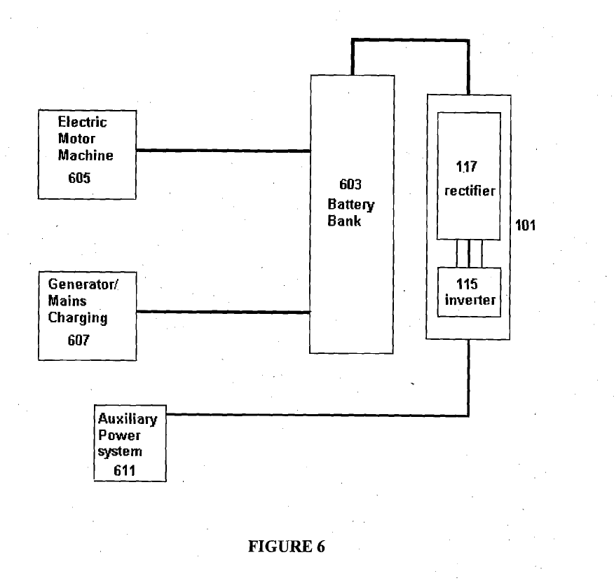

FIG. 6 is an alternative embodiment of the battery augmentation system where the battery augmentation system is used in relation to industrial battery banks.

### PREFERRED EMBODIMENTS

The following description will describe the invention in relation to preferred embodiments of the invention, namely a battery augmentation system and method. The invention is in no way limited to these preferred embodiments as they are purely to exemplify the invention only and that possible variations and modifications would be readily apparent without departing, from the scope of the invention.

### Example 1

FIG. 1 shows a pure form of the battery augmentation system, in which conversion means 101 is connected to the drive-train of a typical electric/gasoline hybrid vehicle such as the Toyota Prius. As mentioned before, the electric-motor-battery 103 of a hybrid vehicle (also referred to as the hybrid battery or battery) supplies power to the electric motor 105 of the vehicle. The electric-motor-battery 103 is in turn charged by the internal combustion engine (ICE) 107 of the vehicle through a generator or alternator 109. The vehicle also includes a separate auxiliary power system 111 to charge an auxiliary battery 113 which supplies power to the electrical systems of the vehicle such as lighting, radio, wipers, etc. This battery 113 is typically a 12V (or 24V) lead-acid automotive battery and the output of the auxiliary power system 111 matches the battery voltage (i.e.: 12V or 24V).

In the example of FIG. 1 the auxiliary power system is an alternator 111 rotated by the ICE 107 of the vehicle. However in electric-only vehicles (and also in some hybrid vehicles) the auxiliary power system 111 is an alternator/converter powered by a regenerative breaking system where the breaking force of the vehicle is used to generate energy and charge the auxiliary battery 113. In some vehicles, the alternator/converter 111 is powered by both a regenerative breaking system and the ICE 107. The battery augmentation system described in this specification can be applied to vehicles equipped with both of these or any other types of auxiliary power systems.

FIG. 1A shows the battery augmentation system installed in an alternative configuration of a hybrid vehicle. As explained previously in PRIOR ART 1A, the electric motor 105 of this configuration also acts as a generator that charges the electric motor battery 103 of the vehicle through an AC-DC inverter 119. The electric motor/generator 105 further provides a charging signal to the auxiliary battery 113 through a DC-DC converter 111. In contrast to FIG. 1, the auxiliary power system in this configuration is a converter 111. As mentioned before the auxiliary power system can be an alternator, converter or any other auxiliary power supply of the vehicle. One or more ECUs 121, 123 and relays 127 control the operation and charging of both batteries 103, 113.

The conversion means 101 (which the inventor has named as ‘Power Jockey’ for commercial purposes) of the battery augmentation system is connected between the auxiliary power system 111 and the electric-motor-battery 103 of a hybrid or electric vehicle. As shown in FIG. 1 and FIG. 1A, in the preferred embodiment of the invention, the conversion means 101 comprises of inverting means 115 and rectifying means 117 which is more clearly illustrated in FIG. 2. The conversion means 101 is also referred to as ‘the device 101’.

FIG. 2 shows a close-up view of the conversion means/the device 101 of the battery augmentation system. The input from the auxiliary power system 111 is connected to the inverting means 115. The inverting means is preferably one or more DC to AC power inverter(s) which can convert a 12V (or 24V) voltage source into a 230V AC voltage signal. Alternatively the inverter(s) can be custom-made for use in the battery augmentation system using readily available parts in the market. In this case the AC output signal of the inverter is a preset value (VAC) such that it supplements the electric-motor-battery voltage of the vehicle. In the preferred embodiment, the inverter used is rated at 1000 watt (ver. 2: 2500 watt) but multiple inverters combined together providing higher power outputs can be used as will be described later. The inverter outputs a single phase AC signal which is fed into the rectifying means 117. The inverter can either output a single phase or a three phase AC voltage signal and a single phase output is used in this embodiment as a design choice.

The rectifying means 117 consists of at least one rectifier 201. The full-wave diode-bridge rectifier 201 converts the single phase AC signal from the inverter 115 into a DC signal. The DC signal is preferably equal (or substantially equal) to the voltage of the electric-motor-battery 103 and in this example it is approximately 310V. However the DC signal does not necessarily need to equal the voltage value of the electric-motor-battery and it can be any other value that adequately supplements the electric-motor-battery 103 of the particular vehicle in which the system is used as will be further explained below.

The rectifying means 117 also includes at least one smoothing capacitor 203 and at least one protection resistor 205. The smoothing capacitor(s) is used to reduce ripple from the voltage output of the rectifier 201 and the resistor limits the output current. A 100 μF smoothing capacitor and a 2.2 Ohm current limiting resistor were included in the prototype device 101 of FIG. 2.

### Trial Results

Initially, several prototypes of the device 101 were built by the inventor and were tested on five different trial vehicles, some having weak or faulty batteries.

A first prototype was installed in parallel in a 1998 Toyota Prius test vehicle which had a weak electric-motor-battery. The vehicle was observed to have more power and acceleration was also smoother with the prototype device 101 installed (achieved 0-60 km/h in approximately 8 seconds during time trials). However the battery quickly deteriorated and power loss occurred in the vehicle when the device 101 was disconnected from the battery. The inventor was forced to stop and re-engage the device 101 in order to continue driving.

A second prototype was installed in a 2001 Toyota Prius generation 2 test vehicle with a suspected faulty battery. The generation 2 Prius vehicle had an on-board computer that calculated fuel economy over a traveled distance. A 10% improvement in fuel economy was observed on a 10 km run with the use of the system.

A third prototype was installed in a 1999 Toyota Prius test vehicle with a battery having a dead cell. The test run was made by the inventor on a section of highway which had steep hill climb. The inventor had managed to complete the test run up the hill on full throttle at speeds of up to 97 kmph. This would not have been possible without the device 101 engaged in the vehicle.

A fourth prototype was installed in a Generation 3 Toyota Prius having a very good battery. This test run was done to check whether the battery augmentation system could also improve the fuel economy of hybrid vehicles having new batteries. Although there was no change in fuel economy when driving on highways, a 20% improvement in fuel economy was observed during city driving. More specifically, without the device 101, the vehicle fuel economy was measured to be 30.8 km/L in city driving and when the device 101 was turned on the fuel economy improved to 36.5 km/L. Therefore this test run proved that the device also provides improvements (in terms of fuel economy) to vehicles having new batteries and is not only beneficial for use in vehicles having weak batteries.

A fifth prototype was installed in a Toyota Estima Hybrid vehicle. A fuel economy test run was done on a 33 km stretch along a highway. The fuel economy of the Toyota Estima was 12.9 km/L without the device and when the test run was repeated on the same stretch of the highway with the device turned on, the Estima achieved 14.8 km/L. This suggests that the battery augmentation system improves the fuel economy of an installed vehicle even when driving on a highway.

At a later trial, the Toyota Estima was fitted with two devices connected in parallel between the auxiliary power system and the electric-motor-battery of the vehicle. This further improved the fuel economy of the vehicle. It was noticed that as the number of devices/conversion means connected to the vehicle increased, both the performance and the fuel economy improved increasingly. This was due to multiple devices allowing the vehicle to function in electric mode for a longer a period of time thus reducing the use of the ICE of the vehicle.

Subsequently, additional trials were carried out with the conversion means/device 101 shown in FIGS. 1 and 2, installed in a series 1 Toyota Prius hybrid vehicle (referred to as the ‘test Prius’ hereinafter). The subsequent trial results were recorded and thoroughly analysed by Progressive Technologies NZ Limited. FIG. 3 show the trial results obtained by measuring the voltage output of the electric-motor-battery in use with and without the battery augmentation system installed in the vehicle. The voltage was measured by connecting a microprocessor based data gathering system including high voltage sensing circuits which measured the electric-motor-battery and conversion means/device voltage outputs under real world dynamic driving conditions.

The electric-motor-battery of the test Prius was an already weakened battery with the output voltage widely fluctuating dependant on the instantaneous driving mode. With the electric-motor-battery charging from the ICE or under regenerative breaking, the battery initially charged to a maximum of 310VDC. Under rapid acceleration up a hill from rest, the battery discharged rapidly to 250VDC. This behaviour is typical of an electric-motor-battery which has lost the ability to store a large amount of charge. The result was the vehicle exhibiting poor acceleration from rest and poor dynamic performance.

The output voltage of the electric-motor-battery is plotted on a voltage (in Volts) vs. time (in seconds) graph shown in FIG. 3. As mentioned before, when the test Prius was operated without the conversion means/device 101, the output voltage dropped rapidly to approximately 250VDC when the vehicle was under heavy acceleration at around 10 seconds into the trial (see curve at 301). This sudden drop of voltage resulted in poor acceleration and a sluggish behaviour of the vehicle. The voltage recovered back to approximately 300VDC when the ICE was automatically re-started by the ECU of the vehicle at around 17 seconds to compensate for the lack of power from the battery.

Next, the test Prius was fitted with the conversion means/device 101 as shown in FIG. 1. It was now evident that the battery voltage drop was a lot less under heavy acceleration at around 10 seconds (see curve at 303), typically falling to only 280VDC under load. A measurable current typically around 2 amps flowed from the conversion means to the electric-motor-battery under these conditions. It was also noted that the restarting of the ICE was delayed till around 26 seconds by the ECU (see curve at 305) since the device 101 was supplementing the battery with sufficient power during this period.

As a result, it appears that under the condition of heavy acceleration up a hill from rest, the conversion means/device 101 is both able to transfer charge to the electric-motor-battery and also prevent the battery from going into the deep discharge region.

The preceding test results with reference to FIGS. 1, 2 and 3 give an overall explanation of the technical aspects of the operation of the battery augmentation system. In essence the device 101 of the battery augmentation system takes power from the 12V (or 24V) auxiliary power system of a hybrid or electric vehicle and uses this to obtain a boosted voltage which can then be used to add supplementary charge to the electric-motor-battery.

Using intuitive logic alone, one would conclude that the battery augmentation system disclosed in this invention will not work. This is particularly apparent given that the amount of power added from the augmentation system (i.e.: 1000 watts in example 1) is too small to make any significant difference, as the power output of the electric motor is 33,000 watts.

Furthermore the fact that the battery augmentation system uses the vehicle's own auxiliary power system 111 means it uses more fuel in a less efficient manner so one would expect higher fuel consumption. However the inventor believes that the way this system works is counter intuitive. Without experience in working with reconditioning hybrid batteries, the way this system functions is not apparent as explained below.

It can be observed from the results graph of FIG. 3 that the boosted voltage output of the conversion means/device 101 is ‘pulled down’ to the electric-motor-battery voltage similar to a wind-generator. It seems this difference in voltage determines how much additional power is supplied from the system. The effect seems pulse-like and is beneficial to the battery as the power supplementation occurs at the time when it is most critical where weak battery sub-packs would fail without the system.

No two parts of an electrical system that are physically joined by a conducting medium can exist at different voltages unless the conducting medium is not perfect. That is, if the conducting medium has an electrical resistance. In this case, the voltage of the electric-motor-battery is separated from the voltage supplied by the rectifier 201 and capacitor 203 of the conversion means by the current limiting resistor 205. Energy cannot flow from the electric-motor-battery into the inverter 115 because of the blocking action of the rectifying diodes 201, therefore the output capacitor 203 charges up through the resistor 205 to the same potential as the electric-motor-battery.

When the electric-motor-battery voltage falls below that of the inverter output 115 (when the battery is under stress due to heavy acceleration) it causes a current to flow from the inverter 115 through the output resistor 205 to the electric-motor-battery which then has the opposite effect of raising the battery voltage to equal the inverter output 115. The greater the voltage drop of the battery, the more power would try to flow from the inverter 115 to the battery. In practice, this is limited by the available power from the inverter 115 and the impedances of the circuitry between the inverter 115 and the battery, in particular the 2.2 Ohm resistor.

It is also observed from the results graph of FIG. 3 that the electric-motor-battery voltage drops to a lower level without the battery augmentation system conversion means 101 connected. It is generally accepted that a complete discharge of cells of the battery until it goes into polarity reversal can cause permanent damage to the cells. This situation occurs in the common arrangement of cells in series, where one is completely discharged before others due to small differences in capacity among the cells of the battery. When this happens, the good cells start to drive the discharged cells in reverse, which can cause permanent damage to the cells. Irreversible damage from polarity reversal is a particular danger in electric-motor-batteries, even when a low voltage threshold cut-out is employed, where cells in the battery are of different temperatures. This is because the capacity of NiMH cells significantly declines as the cells are cooled. This results in a lower voltage under load of the colder cells. The fact that the battery augmentation system of this invention does not allow the cells of the battery to discharge to the same extent may protect the battery of the hybrid or electric vehicle.

The battery augmentation system conversion means 101 prevents the electric-motor-battery from falling below its lower deterioration limit (a predefined level unique to each type of hybrid battery). The fully discharged voltage of the battery of the test Prius is expected to be at or slightly below the batteries nominal voltage of 273VDC. The battery augmentation system conversion means, as measured at its lowest, maintains a voltage of 280VDC or more which is above this lower predefined level.

The ‘Power Jockey’ is the commercial name given to the battery augmentation system conversion means/‘the device’ 101 of this invention because it is similar to a 50 kg jockey (the device) controlling a 1000 kg animal (the vehicle). The ‘Power Jockey’ only outputs a mere 1 kW of power (for the prototype described in example 1) but controls an electric motor that operates at 33 kW of power.

The disclosed prototype battery augmentation system comprises of two operating phases. The first phase is the base voltage support phase. This function was performed by a 12 volt 1000 W inverter 115 outputting 230 volts AC as described above. This phase ensures that the minimum AC voltage of the system is 230 volts (for the prototype). At this minimum voltage each sub pack is prevented from dropping below a predefined voltage (6 volts in the case of the prototype of example 1) thereby preventing excessive discharge and sub pack failure as explained previously.

The second phase is the voltage boost phase. In the prototype, this function was performed by the rectifying means 117 (i.e.: the rectifier 201) which rectified and boosted the voltage to 310 volts DC. The voltage output varies between 280 volts-310 volts DC and it “rides” in support of the voltage of the electric-motor-battery. This feature delivers slightly more power to the electric motor of the vehicle. The overall result of the use of the system is that it keeps the ICE comfortably within its efficient operating range hence more power and fuel economy is gained.

A distinguishing feature of the invention is that it derives its power from the vehicle's own (12 volt) auxiliary power system as described above. This enables the device to operate independently without needing any support from external batteries, as the 12 volt auxiliary power system is always on-hand whenever the vehicle is operating, and hence the battery augmentation system is “always available and working”.

There are several benefits of the battery augmentation system described in this invention as listed below by the inventor. The most notable benefit is the overall increase in power of the vehicle due to the electric motor being used more efficiently. The system also contributes towards the ICE being more powerful as both are now working within its best effective range.

Another notable benefit of the system is the better fuel economy of the vehicle due to the additional supplementation of power. The vehicle engages the electric motor more often. The ICE does not have to function in the low rpm range where it is inefficient. Therefore the acceleration of the vehicle is smooth and quick.

The battery augmentation system protects the electric-motor-battery sub-packs from failure by preventing the battery voltage from falling below the critical threshold (the lower deterioration limit) where the sub-packs will be damaged under load. The system allowed a weak or even damaged electric-motor-battery to work well in the test Prius as the supplemental voltage provided by the system tricked the vehicle computer into accepting that the overall battery voltage is normal as when using a good battery. Holding up the base operating voltage prevented the electric motor from disengaging itself from the drive train of the test Prius.

Using power from the vehicle's own auxiliary power system ensures that the battery augmentation system is functioning at all times during vehicle operation.

Simplicity of the design and use of quality components in its manufacture ensures that the battery augmentation system is robust and reliable. The battery augmentation system is also small and compact and is easily mounted in the boot of the vehicle occupying very little space.

As the battery augmentation system conversion means 101 only needs to be connected to the electric-motor-battery and the vehicle's auxiliary power system, installation is a simple matter and can be done by the vehicle's owner (although it is recommended that installation is done by a professional). Even if installed by a professional its simplicity leads to low cost of installation.

The cost of the conversion means/device 101 is low. It is less than a fraction of the cost of a new replacement electric-motor-battery and even less than the cost of reconditioning the battery. With the device installed, vehicle owners can even choose to replace only the damaged cells in their used battery which is cheaper than a full battery reconditioning service.

When the system is installed in a new vehicle or with a new battery pack it will extend the life of the battery as the battery will have a shallower depth of discharge (DOD) as explained previously. It is conceivable that with the battery augmentation system installed, the hybrid battery could last the lifetime of the vehicle purely because the owner can never accidentally or intentionally stress the battery beyond the point where sub pack damage occurs.

Expensive serviceable parts of the vehicle, such as air flow meters and plugs on coils have to be changed even with little deterioration in efficiency. If left unchanged, the ICE will loose power and it can eventually lead to electric-motor-battery failure because more load is placed on the electric motor. However with the battery augmentation system installed these expensive parts can be used for a longer period leading to less maintenance cost.

Consumers purchase a hybrid vehicle because they can save on fuel and in turn it is also beneficial for the environment. Their only concern would be the high cost of the hybrid battery replacement and the reliability of an older battery as mentioned previously. These concerns are completely ameliorated with the use of the battery augmentation system.

Once confidence in the reliability of hybrid vehicles increases, these vehicles will increase in resale value and many more people will choose to change over to hybrid and electric vehicles. It further means there will be considerable savings to the economy and benefits to the environment.

### Example 2

FIG. 4 shows an alternative embodiment of the invention where charge storage means, namely one or more external batteries 401 are incorporated into the battery augmentation system through the use of a relay switching circuit 403. The relay switching circuit 403 is controlled manually through a switch or automatically through the use of microcontrollers and sensors (not shown). The relay is preferably powered by the 12V auxiliary power system 111 of the vehicle. The relay switching circuit enables the input to the conversion means/device 101 to be selected as desired by a user of the vehicle or as suitable to the driving conditions. The input is selected from (A) input from the vehicle auxiliary power system 111 (as in the previous embodiment) or (B) input from the external battery 401 or (A+B) combined input from the auxiliary power system and the external battery.

The purpose of the external battery 401 is to provide plug-in capability for a vehicle equipped with the battery augmentation system. It is preferably either one or more 12V (or 24V) commercially available lead acid batteries or light weight Lithium ion batteries. However batteries of any other type and voltage can be incorporated into the system as will be explained later. The external battery 401 is coupled to a 12V (or 24V) charging unit 405 to enable charging of the external battery from a 230V AC mains power source or any other suitable power source e.g.: solar/wind generators. The 12V (or 24V) external battery is also charged from the 12V (or 24V) auxiliary power system 111 of the vehicle through the use of a charging regulator (not shown). This allows the battery to be charged “on the go” and as a result, the external battery 401 will always be part of the power train of the hybrid vehicle. This is advantageous over prior art systems (e.g.: PRIOR ART 2) where the second battery pack was no longer a part of vehicle power train when the battery pack was depleted.

It is to be noted that the 12V (or 24V) auxiliary battery 113 of the vehicle does not provide any input to the conversion means/device 101 of this invention (in example 2). It is charged directly from the vehicle auxiliary power system 111 as shown. It is prevented from supplying any power to the battery augmentation system by placing protection means 407 such as, for example a diode(s), fuse(s), or resistor(s) between the battery 113 and the auxiliary power system 111. In this way, the auxiliary battery 113 is only used for powering the electrical systems of the vehicle as mentioned before and is separated from the battery augmentation system.

By incorporating the external battery 401 into the battery augmentation system, it provides an equipped vehicle with plug-in capability. This feature functions differently from other plug in systems on the market as described below.

As described previously in the prior art section, various manufacturers have designed systems for providing plug-in capability for hybrid vehicles. In an extended hybrid battery storage system, the electric-motor-battery can be charged from mains power by increasing the energy storage capacity of the vehicle, effectively reducing use of fuel. In an alternative prior art plug-in design an external first-use battery is used before the vehicle's own electric-motor-battery. This is done by increasing the voltage output of the external first-use battery by a DC to DC converter to a value slightly above the top operating voltage of the vehicle's electric-motor-battery. The external first-use battery is typically 48 volts and is charged from mains power but when depleted, it does not play any further part in the vehicle's operation.

The difference between the plug-in system described in example 2 (FIG. 4) and the prior art designs described above is that unlike the prior art systems using first-use and extended storage plug-in systems, the plug-in system disclosed in example 2 works in support of the vehicle's electric-motor-battery by ‘riding’ the voltage in support of it.

By having an external battery 401 installed, the battery augmentation system is endowed with two power sources, namely the vehicle's auxiliary power system 111 supplying up to 1000 watts and the external battery 401 itself supplying up to 2500 watts. Furthermore the switching relay unit 403 provides the driver of the vehicle three power input choices for selecting a suitable power input for the system using the above two power sources. They are input A which provides power from the vehicle's auxiliary power system only, input B which provides power from the external battery 401 only and input A+B which provides power from both sources as described previously.

The external battery 401 used in this example is equal in voltage to the voltage of the vehicle's auxiliary power system 111 (i.e.: 12V/24V) meaning that in addition to charging the external battery 401 with mains power, it can be charged through the vehicles own auxiliary power system 111. This effectively makes the power in the external battery 401 (input B) available on demand.

There are several benefits of the plug-in system described in this example as listed below by the inventor. It provides better fuel economy to the vehicle as the use of the ICE is reduced. Furthermore power of the external battery 401 is used as and when required only which means it will work for longer periods between charges. The external battery 401 is charged from the vehicle's own auxiliary power system which allows it to be in an “always working” configuration during the operation of the vehicle (i.e.: the external battery is never depleted to the point where it can no longer provide a voltage signal to supplement the electric-motor-battery. The plug-in system can be used with only 1 deep cycle lead acid battery, meaning low installation cost and minimum boot space is required to accommodate the additional external battery 401. The switching unit 403 and mains charging unit 405 is built into the casing of the conversion means 101. Therefore no additional boot space is required other than for the external battery 401. The use of a lead acid battery as the external battery 401 means it has low purchase and installation costs involved.

### Example 3

FIG. 5 shows a block diagram of an alternative embodiment of the conversion means/the device 101.

This block diagram incorporates a switch 503 which represents the ignition switch of the vehicle. This allows the system to be turned on whenever the vehicle key is turned to the ‘on’ position (or ‘start position’ in some vehicles) and be automatically turned off when the vehicle is turned off. Alternatively the switch 503 is a remote on/off switch wired inside the vehicle preferably in to the dash board for the convenience of the driver.

The inverter 115 is used to convert the 12VDC signal, supplied from the auxiliary power system 111 of the vehicle, into a suitable AC voltage (indicated as XXX VAC in FIG. 5) such that the DC voltage output at the rectifier 201 supplements the voltage of the electric-motor-battery of the vehicle. The inverter can be custom designed to convert 12VDC into any required AC voltage depending on the electric-motor-battery of the particular vehicle into which the system is installed.

FIG. 5 also shows at least one smoothing capacitor 505 and at least one protection resistor 507. The smoothing capacitor(s) is used to reduce ripple from the voltage output of the rectifier 201 and the resistor limits the output current. A 4700 μF 450V smoothing capacitor and a 2.2 Ohm current limiting resistor were included in initial trials of the battery augmentation system. The capacitor 505 can also be a super-capacitor of smaller size which allows the system to be more easily integrated into a vehicle.

The inverter 115 further incorporates an overload protection circuit (not illustrated) which automatically turns off the inverter 115 in case of a current draw beyond its maximum capacity is demanded by the battery 103. This could potentially occur for example when a vehicle installed with the system is driven in situations involving heavy acceleration. For example in the 1000 W inverter 115 used in this example, if a current beyond 4 Amps is drawn from the inverter 115, the inverter is automatically turned off by the protection circuit to prevent overloading of the inverter. The protection circuit is usually in-built to the inverter 115 or it can be designed from any prior art overload protection circuits by a person skilled in the art.

In initial prototypes, when an overload of the inverter 115 occurred, a user was required to manually reset the inverter 115 by pressing a reset button of the inverter located in the boot of the installed vehicle. However the inventor has overcome this problem by incorporating one or more thermistors (not illustrated) at the output of the inverter 115 (and/or at the output of the rectifier 117) which prevents the inverter from having to be reset each time it is overloaded. The thermistor(s) limits the current output of the inverter and at hard acceleration periods the inverter is immediately turned off preventing a reset of the inverter and it is automatically restarted afterwards. Therefore the need reset the inverter 115 every time it overloaded is avoided.

In this example, a thermistor is connected to the voltage output of the rectifying means 117. If the current output exceeds 4 A, the thermistor prevents the inverter from resetting and the inverter is automatically turned off. The recommended rating for the thermistor is 10 Ohm (6 A).

### Example 4

FIG. 6 shows a further alternative embodiment of the invention where the battery augmentation system is used to supplement the voltage output of an industrial battery bank 603. The battery bank 603 powers one or more electric motors of industrial machinery 605 and is charged through a mains charging system 607. The conversion means/device is connected to supplement the output of the battery bank to prevent the cells of the battery bank from dropping below its lower deterioration level as explained in the previous examples and hence the same concept of operation described in examples 1-3 is applied in this example.

The battery augmentation system requires power from an auxiliary power system 611 which can be mains power or other power source such as a secondary battery or a diesel generator. The auxiliary power system 611 provides the required power to the inverter 115 and the rectifying means 117 of the device 101 so that the individual batteries of the battery bank are prevented from damage when used to drive heavy loads, for example industrial machines such as lathes, drills or miller machines operating at high rpm. Therefore the use of the battery augmentation system in industrial battery banks provides advantages similar to when using the system in hybrid vehicle batteries.

Component values and voltage values for the operation of the battery augmentation system of this invention for use in battery banks is dependant on the voltage output specific to each battery bank and can be easily determined by scaling the values of previous examples relative to the output voltage of the battery bank to which the system is installed.

### Advantages of the Preferred Embodiments

The conversion means/device 101 is non battery-type specific and will work with any type of battery bank such as Lithium metal hydride, Ferrous phosphate, etc. It taps the auxiliary power supply from a vehicle to bring the terminal voltage of the electric-motor-battery to be above cut-off level of the battery management system of the vehicle.

The DC output signal of the battery augmentation system conversion means in the preferred embodiment of this invention has a base voltage (lowest value) of 280V, a maximum of 310V and the DC output voltage always varies synchronously with the hybrid battery output voltage within this range. This means that the output voltage of the hybrid battery is prevented from dropping below 280V at all times. As mentioned before in the background section, the weakest sub-packs of the hybrid battery usually failed when the voltage drops below a certain critical point under stress. By keeping the hybrid battery voltage above 280V the sub-packs are prevented from reaching this critical value (for example 6 volts minimum for each sub pack) even under stress conditions and hence the battery is safeguarded against failure. In this way, the battery augmentation system of this invention prevents hybrid battery failure. It should be noted that the base voltage of 280V and maximum of 310V only applies to the trial vehicle of the inventor (i.e.: Toyota Prius series 1/2) and can vary depending on the battery type, vehicle make and model or type of components used in the system.

Furthermore the NiMH hybrid battery of a hybrid vehicle can be used for up to 500 cycles since it is never discharged beyond its depth of discharge (DOD) rating, giving it a useful life of approximately 8-10 years. With the use of the battery augmentation system, the battery discharge is even shallower and hence the system extends the useful lifetime of the battery for many more years.

The system has been installed on a Toyota Prius MK1 trial vehicle of the inventor. The most important drive train in these hybrid vehicles is the electric motor drive. It provides the low end torque and the internal combustion engine cannot function without the electric motor system. When there is not enough low end torque present (i.e.: hybrid battery failure) the electric motor disengages and the internal combustion engine revs high since the motor is unable to move the vehicle forward. This system ensures that the low end torque is always available from the electric motor by supplementing the hybrid battery voltage output and preventing the voltage from dropping to low values as mentioned above. Therefore this system further ensures that the electric motor of the vehicle is working at a maximum reducing the part played by the internal combustion engine, increasing the power output of the electric motor and decreasing the vehicle's fuel consumption.

The battery augmentation system of this invention improves the condition and extends the useful lifetime of even weak hybrid batteries. A trial was done by the inventor on an aged Toyota Prius having a main hybrid battery with two weak cells. The vehicle was showing low power/battery failure warning lights on the dash board (triangle symbol and the turtle symbol). It was shown that once the system was installed in the vehicle, the car had a tremendous amount of power and acceleration and was performing better than when the system was not installed. In the trial the inventor was able to accelerate and maintain a speed of 100 KPH going uphill even when the low power/battery failure (turtle) dash icon was showing and the battery capacity level meter was in the yellow. Later, when the battery augmentation system conversion means was disconnected from the vehicle, the hybrid battery quickly failed and the internal combustion engine started compensating by revving high.

The battery augmentation system disclosed in this invention is cheaper than prior art systems. The cost is only for an inverter(s), the rectifying unit (the rectifier, capacitor and resistor) and installation. In the alternative embodiment of FIG. 4, the cost is slightly increased with the inclusion of an optional external battery (including charging and switching assembly). Furthermore as mentioned before, it is not essential to have the optional external battery for the system to function, further reducing the cost of the battery augmentation system.

The lack of use of multiple batteries also reduces the weight added to the vehicle as a result of installation. The weight of the electronics of the system is minimal compared to the weight of having multiple batteries (as done in the prior art). Therefore the use of the system would be more fuel efficient than using prior art systems due to the reduced weight. The lack of multiple batteries also reduces the amount boot space taken and the entire system can be installed above the hybrid battery of the vehicle. Therefore, the system disclosed in this invention does not hinder access to the spare wheel of the vehicle and leaves ample boot space for the vehicle user.

The battery augmentation system of this invention uses the vehicle's own auxiliary power system (12/24V) to provide the input power for the system. This enables the system to be ‘always working’ during the operation of the vehicle even without using the optional external battery (12/24V) 401 shown in FIG. 4 (i.e.: the system never stops supplementing the electric-motor-battery of the vehicle as long as the vehicle is in operation).

Furthermore in the alternative embodiment of the invention of FIG. 4, the optional external battery is always charged ‘on-the-go’ by the auxiliary power system of the vehicle. This means that the external battery is never completely drained out and the battery augmentation system is always part of the power train of the vehicle, augmenting the voltage of the main hybrid battery at all times. This is in contrast to prior art systems where secondary battery packs were no longer part of the vehicle power train once drained out, as mentioned before.

Even furthermore preventing the external battery from completely draining out extends the useful lifetime of the external battery 401.

Unlike prior art systems, the battery augmentation system of this invention does not charge the main hybrid battery of the vehicle at any time. This system acts more like a battery assist system than a plug-in charging system and is designed to work ‘alongside’ the main hybrid battery. It can be thought of as a second hybrid battery placed in parallel with the existing main hybrid battery.

The battery augmentation system disclosed in this specification is novel and inventive over the prior art since prior art systems have not dealt with the issue of reconditioning or reusing aged weakened hybrid batteries. In the prior art (including in the Enginer system described earlier), if the main hybrid battery failed (i.e.: one or more of the sub-packs failed to hold charge) it was discarded as recommended by the manufacturers. The inventor is the only person involved in reconditioning of hybrid vehicle batteries in New Zealand (to the best of his knowledge) and therefore he was able to invent this system with his experience in reconditioning these types of batteries over the years by directly addressing the cause of hybrid battery failure.

Hybrid vehicle batteries are expensive to replace and hence a failed battery of a hybrid vehicle such as a Toyota Prius usually results in the vehicle being sold for scrap metal. The vehicle cannot function and is rendered useless without a functioning hybrid battery. Battery reconditioning is an option but failure is still imminent. However by using this system, the life of vehicles with even weakened batteries can be reliably extended allowing aged vehicles to be used for many more years. Therefore the use of this system increases the resale value of aged hybrid vehicles and prevents the vehicle being prematurely discarded. Extending the useful lifetime of hybrid/electric batteries and/or vehicles is good for the environment. This reduces the use of natural resources and energy in manufacturing new or replacement hybrid batteries and vehicles. Furthermore it can be regarded as environmentally-friendly since it reduces the pollution caused by discarded hybrid batteries and vehicles.

The battery augmentation system of this invention is an enabling technology which makes other spin-off lucrative business models viable such as the green car rental concept. Currently second hand hybrid vehicles are cheap but unreliable. However with the battery augmentation system installed, a fleet of ageing hybrid vehicles (such as the popular 8-seater Toyota Estima) can be used to create a highly profitable rental car business.

### Variations

As mentioned before, the disclosed battery augmentation system is not limited to use in electric/gasoline vehicles and can be used in other hybrid vehicles, including series and/or parallel hybrids and electric-only vehicles. Examples are hybrid/electric vehicles which use regenerative breaking to charge an auxiliary battery of the vehicle. In vehicles using regenerative breaking systems (RBS), the charging output of the auxiliary alternator/converter is connected directly to the inverter 115 input shown in FIG. 1 or to the relay switching unit 403 of FIG. 4. The output of the battery augmentation system conversion means is connected to the main hybrid or electric battery of the vehicle as explained previously. All other aspects of the system are the same with similar results being obtained as with electric/gasoline vehicles.

In example 2 illustrated in FIG. 4, the external battery 401 can be of any type and voltage suited for being integrated with the auxiliary power system 111 for providing a plug-in option for the vehicle. The battery voltage should match the auxiliary power operating voltage of the vehicle which is typically 12V/24V as mentioned previously. The battery 401 is a lead-acid battery as stated in the example but it can also be one or more light-weight, long-duration, high capacity batteries derived from new emerging battery technologies. Examples include Lithium ion and Lithium ion polymer (LiPo) batteries.

The optional external (12/24V) battery 401 of FIG. 4 is used as a power storage means for ‘plug in’ operation of the system and is charged from AC mains power and the vehicle's own auxiliary power system as mentioned previously. In alternative embodiments, the optional external battery can also be charged from other power generation means built-in or mounted on the vehicle such as solar panels, wind generators, additional alternators and heat exchangers. These alternative power generation means can be incorporated into the system using commonly known prior art charging methods. One possible method of incorporating wind generators into the system is to incorporate them within the spoilers of the vehicle.

In the alternative embodiment of the invention shown in FIG. 4, the relay switching unit 403 selects inputs A, B or A+B as mentioned before. At the inputs A and B, the relay switching unit has inbuilt current-limiting resistors or fuses (not shown). The current-limiting resistors/fuses are used to prevent excess current being drawn from the inputs A/B which can cause damage to the auxiliary power system 111 and/or external battery 401. These safety resistors limit the maximum current input supplied from the vehicle auxiliary power system (input A) to 100 A and the maximum current input supplied from the external battery (input B) to 200 A. Therefore in this example the maximum current input to the conversion means/device 101 when both inputs A and B are selected is 300 A. However maximum current ampere values may vary depending on the particular system and the vehicle in which the system is installed. Furthermore the location of the safety resistors/fuses may vary and can be located at the inputs A and B, within or at the output of the relay unit, the inverter or the rectifying unit.

The system includes further protection means such as fuses, resistors and protective diodes (e.g.: diode/fuse 407) to provide safety from over current conditions and to prevent any current accidently travelling in the reverse direction.

Furthermore, relating to the embodiment of FIG. 4, input B may not be used as an input to the system (from external battery 401) in some alternative implementations and it may only be a charging connection which only allows the external battery to be charged from the vehicle auxiliary power system 111. Therefore in some embodiments it may not necessarily be in the ‘always on’ state contributing to the system.

The conversion means/device 101 (inverting means 115+rectifying means 117) can be combined into one and manufactured as a more compact unit making it easier to be installed in a vehicle and reducing used space. Furthermore the battery augmentation system of this invention can incorporate any type of conversion means and is not limited to the inverting means 115 and rectifying means 117 disclosed in the above embodiments. For example the conversion means can include other means of power conversion such as, for example, a transformer, a DC-DC converter or a mechanical conversion unit comprising a DC motor, an alternator and a rectifier which supplements the hybrid battery voltage preventing it from dropping to dangerously low values.

The inverting means 115 is a 12VDC-230VAC (or other required AC value) inverter having a maximum power output of 1000 W as described previously. However inverters of higher or lower power/voltage output capacities (e.g.: 2500 W) can be used in the system which allows more or less power to be delivered to the electric-motor-battery 103 as required. The AC output voltage of the inverter is selected according to the particular electric-motor-battery voltage of the vehicle on which the system is installed as described previously. Furthermore multiple inverters can be connected together in parallel to further increase the total power output of the inverting means 115.

The system can be retrofitted to all existing hybrid vehicles in the market. Furthermore it should be considered as part of the vehicle design built into all newly manufactured hybrid vehicle models. Therefore the system can be built in at the manufacturing plant as an optional (or compulsory) feature in new vehicles and also sold as a stand-alone aftermarket kit installed by the owner/third party.

Although the battery augmentation system is described as applied to a hybrid vehicle such as the Toyota Prius, it can also be applied to other hybrids such as the Honda Insight and the Honda Civic Hybrid by making slight modifications to operating voltage values of the system. For example, the Honda Insight main hybrid battery only uses half the number of sub-packs of the Prius hybrid battery and hence all values of the battery augmentation system is scaled down by half (i.e.: the inverter output is halved to 120V and the Power Jockey output which supplements the battery is also halved. However the system operates under the same principles in alt vehicles as described before.

The term ‘main hybrid battery’ refers to the battery or batteries which are used to run the main electric motor(s) of a hybrid, electric or other type of vehicle.

The term ‘electric-motor-battery’ refers to any battery or group of batteries which are used power an electric motor. Examples include the main battery of a hybrid or electric vehicle which powers an electric motor(s) of the vehicle and also includes any battery or battery bank used to power an industrial machine incorporating an electric motor(s) such as a lathe, drill or miller machine. This term encompasses the definition of the ‘main hybrid battery’ given above.

The term ‘auxiliary power system’ refers to a 12V/24V auxiliary battery charging system of a vehicle as mentioned previously. In hybrid vehicles the auxiliary power system is usually an alternator, generator or a converter (see FIG. 1/1A) powered by, for example, the ICE, the electric motor generator and/or a regenerative breaking system and also includes an auxiliary battery which is typically a 12V/24V lead acid battery, both of which are used to power auxiliary devices of the vehicle such as lights, wipers, radio, etc. The term ‘auxiliary power system’ is not limited to a battery/charging system and also covers any power supply system of a hybrid or electric vehicle which is present in addition to the main power/charging system (which charges the main-electric-motor-battery) of the vehicle. Furthermore the auxiliary power system may be derived from the power/charging system which directly charges the electric-motor-battery (e.g.: FIG. 1A) or alternatively it may be a separate power supply system.

In some vehicles, the auxiliary power system may not necessarily power auxiliary devices of the vehicle and it includes' any power supply system specifically built into the vehicle for powering the battery augmentation system of this invention. This includes any alternate power and/or charging systems designed by vehicle manufacturers or third parties for the purpose of supplementing the voltage of the electric-motor-battery including regenerative breaking systems, solar/wind powered generators, one or more batteries charged through AC mains power or other power sources (e.g.: fuel cells, solar panels, vehicle electric-motor-battery, etc) or other type alternate power generation systems. Furthermore it covers power supply systems of any voltage value and is not necessarily limited to the commonly found 12V/24V vehicle auxiliary charging systems.

The term ‘auxiliary power system’ is not limited to power and/or charging systems of vehicles. As described in example 4, the ‘auxiliary power system’ can also refer to any industrial power source used for powering a battery augmentation system described in this invention used for augmenting industrial battery banks. Therefore it extends to cover any power source(s), used for augmenting a battery(s) by preventing cell damage caused during the operation of a load(s) (e.g.: an electric motor).

The terms ‘the conversion means’ and ‘the device’ are used interchangeably.

The term ‘battery circuit’ and the phrase ‘adapted to be coupled, in use, to a battery or battery circuit’ as defined in the claims, is used to indicate that the conversion means is coupled either to the battery directly or any part of a circuit of the vehicle which allows the conversion means to supply a voltage signal to the battery. In a hybrid or electric vehicle, this circuit may be a relay circuit, a fuse board or any other wire/cable/circuit which is directly or indirectly in connection with the battery terminals.

Throughout the description of this specification, the word “comprise” and variations of that word such as “comprising” and “comprises”, are not intended to exclude other additives, components, integers or steps.

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

1. A battery augmentation system comprising, at least one conversion means wherein the conversion means is adapted to be coupled, in use, to an auxiliary power system for receiving an output signal from the auxiliary power system, the conversion means being capable of converting the output signal from the auxiliary power system into a converted signal and the conversion means further being adapted to be coupled, in use, to a battery or battery circuit for providing the battery with the converted signal to thereby supplement the battery, wherein supplementing the battery prevents the battery output voltage from dropping below a predefined level, thus preventing damage to the battery.

2. A battery augmentation system as claimed in claim 1, wherein the battery augmentation system is a battery augmentation system for use in a hybrid or electric vehicle and the auxiliary power system includes an alternator, converter or other power conversion means powered by, for example, an internal combustion engine, a regenerative breaking system, one or more batteries, electric motor generators, solar/wind power generators or other means.

3. A battery augmentation system as claimed in claim 2, wherein the battery is an electric-motor-battery of the vehicle.

4. A battery augmentation system as claimed in claim 1, wherein the battery augmentation system is a battery augmentation system for use in an industrial battery bank and the auxiliary power system is an alternator, converter or other power conversion means powered by mains power or other power source(s).

5. A battery augmentation system as claimed in claim 3, wherein the conversion means comprises of inverting means and rectifying means wherein the inverting means converts the output signal from the auxiliary power system into an AC signal, and the rectifying means rectifies the AC signal into the converted signal, the converted signal being a DC converted signal.

6. A battery augmentation system as claimed in claim 3, wherein the converted signal prevents the electric-motor-battery output voltage from dropping below a predefined level, particularly when the electric-motor-battery is under stress during heavy demand periods of the electric motor of the vehicle.

7. A battery augmentation system as claimed in claim 3, wherein the system further comprises charge storage means coupled to the auxiliary power system of the vehicle.

8. A battery augmentation system as claimed in claim 7, wherein the charge storage means is also coupled to a charging unit which allows the charge storage means to be plugged in and charged through AC mains power or other external power sources such as solar powered charging.

9. A battery augmentation system as claimed in claim 7, wherein the charge storage means is coupled to the auxiliary charging system such that the charge storage means is continuously charged from the vehicle's auxiliary power system.

10. A battery augmentation system as claimed in claim 7, wherein the charge storage means is one or more 12V (or 24V) lead acid, lithium ion or any other type of batteries.

11. A battery augmentation system as claimed in claim 7, wherein the charge storage means is capable of supplying an output signal to the conversion means and the system comprises of switching means for selecting an output signal to be supplied to the conversion means, the output signal being chosen from the auxiliary power system, the charge storage means or both.

12. A battery augmentation system as claimed in claim 5, wherein the output signal from the auxiliary power system is, for example, a 12V (or 24 V) DC signal and the conversion means converts the 12V (or 24V) DC signal into a DC voltage signal corresponding to the electric-motor-battery voltage.

13. A battery augmentation system as claimed in claim 5, wherein the rectifying means includes one or more diode rectifiers, capacitors and resistors.

14. A battery augmentation system as claimed in claim 6, wherein the converted signal prevents the output voltage of the electric-motor-battery from dropping below a predefined level, even when the electric-motor-battery is under stress, the predefined level being a value unique to each type of electric-motor-battery, for example 280VDC.

15. A battery augmentation system as claimed in claim 3, wherein the battery augmentation system is in an ‘always working’ configuration with the electric-motor-battery during operation of the vehicle.

16. A battery augmentation system as claimed in claim 3, wherein the battery augmentation system provides increased power and/or an increase in fuel economy to a vehicle with the system installed and in particular to a vehicle having a suspected weak electric-motor-battery.

17. A battery augmentation system as claimed in claim 3, wherein the battery augmentation system is capable of being installed in all hybrid and/or electric vehicles, and in particular in the Toyota Prius (generation 1—NHW 10, generation 2—NHW 11 and generation 3—NHW20), Honda Insight and Honda Civic hybrid.

18. A battery augmentation system as claimed in claim 3, wherein the battery augmentation system is turned on or off by a remote switch or by the ignition switch of the vehicle so that the system turns on or off simultaneously with the vehicle starting or turning off.

19. A battery augmentation system as claimed in claim 1, wherein the battery augmentation system further comprise one or more thermistors coupled to the conversion means for limiting the current output from the conversion means preventing the conversion means from overloading.

20. A hybrid or electric vehicle having at least one conversion means wherein the conversion means is operatively connected to an auxiliary power system of the vehicle, the conversion means converting an output signal from the auxiliary power system into a converted signal, the converted signal being supplied to an electric-motor-battery of the vehicle, the converted signal supplementing the electric-motor-battery output voltage, wherein supplementing the electric-motor-battery output voltage with the converted signal prevents the electric-motor-battery output voltage from dropping below a predefined level, thus preventing damage to the electric-motor-battery.

21. A device for use in a vehicle, wherein the device is adapted to be coupled, in use, to an auxiliary power system of the vehicle for receiving an output signal from the auxiliary power system, the device being capable of converting the output signal from the auxiliary power system into a converted signal and the device further being adapted to be coupled, in use, to an electric-motor-battery or battery circuit of the vehicle for providing the electric-motor-battery with the converted signal to thereby supplement the electric-motor-battery, wherein supplementing the electric-motor-battery prevents the electric-motor-battery output voltage from dropping below a predefined level, thus preventing damage to the electric-motor-battery.

22. A battery augmentation method for augmenting a battery, the method comprising the steps of:
converting an output signal from an auxiliary power system into a converted signal through conversion means,
supplying the converted signal to the battery or battery circuit thereby supplementing the battery output voltage,
such that supplementing the battery output voltage with the converted signal prevents the battery output voltage from dropping below a predefined level, thus preventing damage to the battery.

23. A method as claimed in claim 22, wherein the method includes a preliminary step of connecting conversion means between the auxiliary power system and the battery or battery circuit.

24. A method as claimed in claim 22, wherein the method is for augmenting a battery of a vehicle.

25. A method as claimed in claim 22, wherein the conversion means includes inverting means and rectifying means.

26. A method as claimed in claim 25, wherein the converting of the output signal through the conversion means involves the inverting means converting the output signal into an AC signal and the rectifying means converting the AC signal into a DC converted signal.

27. A battery augmentation system for a hybrid or electric vehicle, the system comprising at least one conversion means, the conversion means capable, in use, of being connected between an auxiliary power system and an electric-motor-battery of the vehicle, wherein the conversion means is capable, in use, of converting an output signal from the auxiliary power system into a converted signal and supplying the converted signal to the electric-motor-battery, thereby supplementing the output voltage of the electric-motor-battery, thus preventing the output voltage of the electric-motor-battery from dropping beyond a predetermined value and preventing damage to cells of the electric-motor-battery.

28. An add-on kit for a hybrid or electric vehicle, the add-on kit including at least one conversion means, the conversion means capable, in use, of being connected between an auxiliary power system and an electric-motor-battery of the vehicle, wherein the conversion means is capable, in use, of converting an output signal from the auxiliary power system into a converted signal and supplying the converted signal to the electric-motor-battery, thereby supplementing the output voltage of the electric-motor-battery, thus preventing the output voltage of the electric-motor-battery from dropping beyond a predetermined value and preventing damage to cells of the electric-motor-battery.

29. A battery augmentation system comprising, at least one conversion means wherein the conversion means is operatively connected to an auxiliary power system, the conversion means converting an output signal from the auxiliary power system into a converted signal, the converted signal supplementing an output voltage of a battery, wherein supplementing the battery output voltage with the converted signal prevents the battery output voltage from dropping below a predefined level, thus preventing the battery from being damaged.
